(19) United States
(12) Patent Application Publication
(10) Pub. No.: US 2025/0202044 A1
(43) Pub. Date: Jun. 19, 2025

(54) MICROPOROUS SEPARATOR FOR LITHIUM BATTERY AND PREPARATION METHOD THEREOF

(71) Applicants: SENIOR (FOSHAN) NEW MATERIAL TECHNOLOGY CO., LTD., Foshan (CN); SHENZHEN SENIOR TECHNOLOGY MATERIAL CO., LTD., Shenzhen (CN)

(72) Inventors: Qi CAI, Shenzhen (CN); Lujing Lin, Shenzhen (CN); Mengquan Liu, Shenzhen (CN); Wuhua Xiao, Shenzhen (CN); Di Xiong, Shenzhen (CN); Yiping Chen, Shenzhen (CN); Yulin Lin, Shenzhen (CN)

(21) Appl. No.: 19/070,321

(22) Filed: Mar. 4, 2025

Related U.S. Application Data
(63) Continuation of application No. PCT/CN2024/102443, filed on Jun. 28, 2024.

(30) Foreign Application Priority Data
Jul. 14, 2023 (WO) PCT/CN2023/107568

(51) Int. Cl. H01M 50/417; H01M 10/0525; H01M 50/403; H01M 50/491

(52) U.S. Cl. CPC H01M 50/417; H01M 10/0525; H01M 50/403; H01M 50/491

(57) ABSTRACT

The present disclosure relates to a microporous separator for lithium battery and its preparation method. Specifically, the present disclosure provides a microporous separator for lithium battery including a polyolefin resin, having excellent resilience performance and compression resistance performance in its thickness direction; the present disclosure also provides a preparation method for a highly resilient microporous separator for lithium battery.

### CROSS-REFERENCE TO RELATED APPLICATION

This application is a continuation of International Application No. PCT/CN2024/102443, filed on Jun. 28, 2024, which claims priority to International Application No. PCT/CN2023/107568, filed on Jul. 14, 2023. The disclosures of the aforementioned applications are hereby incorporated by reference in their entireties.

### TECHNICAL FIELD

The present disclosure relates to the technical field of lithium-ion batteries, specifically to a microporous separator for lithium battery and a preparation method thereof.

### BACKGROUND

Polyolefin-based microporous membrane is widely used as a separation membrane for separation and selective permeation of various substances, and an isolation material, etc. For example, polyolefin-based microporous membrane is used as a precision filtration membrane, a separator for fuel cell, a separator for capacitor, a base material for functional membrane which is filled with functional materials in pores in order to show new functions, a separator for battery, etc. Among these applications, polyolefin-based microporous membrane is particularly suitable for use as a separator for lithium-ion batteries widely used in laptops, mobile phones, digital cameras, and the like. As its reasons, it can be enumerated that the polyolefin-based microporous membrane has excellent membrane mechanical strength and shutdown characteristics.

In addition, for a microporous separator for lithium battery, good resilience performance in a thickness direction is also required to ensure that the microporous separator undergoes smaller deformation in the thickness direction when the battery is subjected to impact in the thickness direction, and can be recovered more quickly when the impact force is removed, thereby ensuring the safety performance of the battery.

Although the prior art focuses on compression deformation rate, there is still a need for a separator with a high resilience rate in the thickness direction. Especially, a separator with a high resilience rate, a low compression deformation rate, and a large resilience amount in the thickness direction is still needed.

### SUMMARY

The present disclosure achieves a separator for lithium-ion battery with high resilience rate in a thickness direction by controlling a quantity proportion of high molecular weight chain segments in the polyolefin resin. In addition, the separator of the present disclosure also has a small compression deformation rate and a large resilience amount.

It is also found in the present disclosure that by controlling the parameters of the extrusion step in the separator manufacturing process, it is helpful to control the compression resistance of the separator.

A first aspect of the present disclosure provides a microporous separator for lithium battery, including a polyolefin resin. The microporous separator has a melt index of 0.04 g/10 min-3 g/10 min, for example 0.08 g/10 min-0.4 g/10 min. In the microporous separator, a quantity proportion of polyolefin chain segment ingredients with a weight-average molecular weight of 2 million to 5 million is 5 mol %-8 mol %, for example 5 mol %-7 mol %; and a resilience speed of the microporous separator in its thickness direction is greater than or equal to 2×10⁻⁴ m/s, for example, greater than or equal to 3×10⁻⁴ m/s, greater than or equal to 5×10⁻⁴ m/s, greater than or equal to 7×10⁻⁴ m/s, greater than or equal to 8×10⁻⁴ m/s, and greater than or equal to 10×10⁻⁴ m/s; and
the resilience speed of the microporous separator in its thickness direction is calculated by the following formula:

$$V = ( D 2 - D 1 ) / ( T 2 - T 1 )$$

in the formula, V—the resilience speed, measured in m/s,
D2—a thickness of microporous separator when its compressive loading force is reduced to 30 mN, measured in m,
D1—a thickness of microporous separator when its compression deformation reaches the lowest point, measured in m,
T2—time required for the compressive loading force of the microporous separator to be reduced to 30 mN, measured in s,
T1—time required for the compression deformation of the microporous separator to reach the lowest point, measured in s,
test condition: the microporous separator is subjected to a loading force of 500 mN in its thickness direction, and kept the loading force for 300 s, followed by reducing a value of the loading force at a rate of 30 mN/min.

In some embodiments, the quantity proportion of polyolefin segment ingredients with a weight-average molecular weight greater than 5 million and below 9 million in the microporous separator is 0 mol %-1 mol %, for example 0.5 mol %-1 mol %.

In some embodiments, the microporous separator satisfies one or more of the following:
a. when measured under the test condition, a compression deformation rate of the microporous separator in its thickness direction is less than or equal to 2.5%, for example less than or equal to 1.8%, less than or equal to 1.5%, and less than or equal to 1%;
b. when measured under the test condition, a resilience recovery rate of the microporous separator in its thickness direction is greater than or equal to 0.5%, for example greater than or equal to 1%, greater than or equal to 1.5%, greater than or equal to 2%, and greater than or equal to 3%;
where,

$$the compression deformation rate = ( original thickness - thickness when the compression deformation reaches the lowest point ) / original thickness \times 100 \% ,$$

$$a resilience deformation rate = ( original thickness - thickness when the compressive loading force is reduced to 30 mN ) / original thickness \times 100 \% ,$$

$$a resilience recovery rate = \vert the compression deformation rate - the resilience deformation rate \vert .$$

In some embodiments, the polyolefin resin has a molecular weight distribution between 3 and 5, for example between 3.5 and 4.5

In some embodiments, the quantity proportion of polyolefin chain segment ingredients with the weight-average molecular weight of 2 million to 5 million in the polyolefin resin is 5 mol %-9 mol %, for example 5 mol %-8 mol %, and 6 mol %-8 mol %.

In some embodiments, the quantity proportion of polyolefin chain segment ingredients with a weight-average molecular weight greater than 5 million and below 9 million in the polyolefin resin is 0 mol %-2 mol %, for example 1 mol %-1.5 mol %.

In some embodiments, the microporous separator is a separator prepared by a wet process.

In some embodiments, the polyolefin resin is selected from polyethylene (including, for example, LDPE, LLDPE, HDPE, UHDPE), polypropylene, polybutene, polymethylpentene, a copolymer thereof, or a mixture thereof.

In some embodiments, the microporous separator has an average pore diameter of 25 nm-50 nm, for example 30 nm-45 nm; and the microporous separator has a thickness of 1 m-30 m, for example 4 m-12 m.

A second aspect of the present disclosure provides a preparation method for a microporous separator for lithium battery, including the following steps:
(a) melting and blending a mixture containing a polyolefin resin and a plasticizer to form a melt;
(b) extruding and solidifying the melt obtained in step (a) to obtain a thick sheet;
(c) stretching the obtained thick sheet in a machine direction (MD direction) and in a transverse direction (TD direction) perpendicular to the machine direction to obtain a stretched sheet;
(d) removing the plasticizer from the stretched sheet to obtain a precursor of separator;
(e) heat-setting the precursor of separator to obtain the microporous separator for lithium battery;
where, the polyolefin resin has a melt index of 0.01 g/10 min-3 g/10 min, for example 0.05 g/10 min-0.3 g/10 min; and a quantity proportion of polyolefin chain segment ingredients with a weight-average molecular weight of 2 million to 5 million in the polyolefin resin is 5 mol %-9 mol %, for example 5 mol %-8 mol %, and 6 mol %-8 mol %.

In some embodiments, in step (a), the quantity proportion of polyolefin chain segment ingredients with a weight-average molecular weight greater than 5 million and below 9 million in the polyolefin resin is 0 mol %-2 mol %, for example 1 mol %-1.5 mol %.

In some embodiments, the quantity proportion of polyolefin chain segment ingredients with a weight-average molecular weight greater than 5 million and below 9 million in the microporous separator is 0 mol %-1 mol %, for example 0.5 mol %-1 mol %.

In some embodiments, the polyolefin resin has a molecular weight distribution between 3 and 5, for example 3.5-4.5.

In some embodiments, the quantity proportion of polyolefin chain segment ingredients with a weight-average molecular weight of 2 million to 5 million in the microporous separator is 5 mol %-8 mol %, for example 5 mol %-7 mol %.

In some embodiments, a resilience speed of the microporous separator in its thickness direction is greater than or equal to 2×10⁻⁴ m/s, for example greater than or equal to 3×10⁻⁴ m/s, greater than or equal to 5×10⁻⁴ m/s, greater than or equal to 7×10⁻⁴ m/s, greater than or equal to 8×10⁻⁴ m/s, and greater than or equal to 10×10⁻⁴ m/s; and
where, the resilience speed of the microporous separator in its thickness direction is calculated by the following formula:

$$V = ( D 2 - D 1 ) / ( T 2 - T 1 )$$

in the formula, V—resilience speed, measured in m/s,
D2—a thickness of the microporous separator when its compressive loading force is reduced to 30 mN, measured in m,
D1—a thickness of the microporous separator when its compression deformation reaches the lowest point, measured in m,
T2—time required for the compressive loading force of the microporous separator to be reduced to 30 mN, measured in s,
T1—time required for the compression deformation of the microporous separator to reach its lowest point, measured in s,
test condition: the microporous separator is subjected to a loading force of 500 mN in its thickness direction, and kept this loading force for 300 s, followed by reducing the value of the loading force at a rate of 30 mN/min.

In some embodiments, in step (a), a weight ratio of the polyolefin resin to the plasticizer is between 15:85 and 35:65, for example between 18:82 and 23:77.

In some embodiments, in step (a), an extruder is used for melting and blending, and the extruder has parameters including: an extruder temperature of 150° C.-260° C. and an extruder screw speed of 60 r/min-125 r/min.

In some embodiments, in step (b), the mixture is extruded through a die lip of a die and attached to a casting roller for cooling and solidifying to form a thick sheet; and a die lip opening is a, a thickness of the thick sheet is h, and an expansion coefficient is defined as A=h/a, A being controlled to be greater than or equal to 1.2.

In some embodiments, the casting roller has a roll speed of 3 m/min-8 m/min, and the die has a temperature of 160° C.-240° C.

In some embodiments, in step (c), the stretching in the MD direction is carried out at 80° C.-120° C. with a stretching ratio of 4 to 7, and the stretching in the TD direction is carried out at 90° C.-130° C. with a stretching ratio of 4 to 12.

In some embodiments, in step (e), the heat-setting comprises an oven heat treatment and a roller heat treatment, and in some embodiments, the oven heat treatment has a temperature of 120° C.-150° C., and the roller heat treatment has a temperature of 50° C.-70° C.

In some embodiments, the polyolefin resin is selected from polyethylene (including, for example, LDPE, LLDPE, HDPE, UHDPE), polypropylene, polybutene, polymethylpentene, a copolymer thereof, or a mixture thereof.

### DESCRIPTION OF EMBODIMENTS

Before further describing the present disclosure, certain terms used in the description, embodiments, and appended claims are collected in the following paragraphs. The definitions listed herein should be read and understood by the person skilled in the art according to the remaining parts of the present disclosure. Unless otherwise defined, all technical and scientific terms used herein have the same meanings as those commonly understood by the person skilled in the art to which the present disclosure belongs.

The terms “one” and “another” as used herein, are only for descriptive purposes and should not be understood as indicating or implying relative importance or implicitly specifying the number of technical features indicated.

The term “about” as used herein, when referring to a value, means including its variations, such as ±10%, ±5%, ±1%, or 0.1% of a specific value.

The term “substantially the same” as used herein, when referring to two values, means that the difference between the two values is less than 10%, 5%, or 1% of an average of the two values.

The term “polyolefin” as used herein may be a polyolefin monomer (i.e., a single type of polyolefin), a polyolefin copolymer, or a polyolefin mixture.

The term “mixture” as used herein refers to a physical mixture of two or more homopolymers with different molecular structures, two or more copolymers with different molecular structures, or both homopolymer and copolymer that have different molecular structures. Specifically, the mixture may include different polymers, i.e., at least two polymers with different chemical properties (such as polyethylene, polypropylene, and/or a copolymer of ethylene and propylene with different chemical properties); and/or polymers with the same chemical property but different characteristics (such as two different types of polyethylene with different characteristics (e.g., density, molecular weight, molecular weight distribution, rheology, additive (composition and/or percentage), etc.)).

The term “machine direction” as used herein, also known as MD direction, refers to a direction in which the machine is operated.

The term “transverse direction” as used herein, also known as TD direction, refers to a direction perpendicular to a direction in which the machine is operated.

A first aspect of the present disclosure provides a microporous separator for lithium battery including a polyolefin resin. The microporous separator has a melt index of 0.04 g/10 min-3 g/10 min, for example 0.08 g/10 min-0.4 g/10 min; the quantity proportion of polyolefin chain segment ingredients with a weight-average molecular weight of 2 million to 5 million in the microporous separator is 5 mol %-8 mol %, for example 5 mol %-7 mol %; a resilience speed of the microporous separator in its thickness direction is greater than or equal to 2×10⁻⁴ m/s, for example greater than or equal to 3×10⁻⁴ m/s, greater than or equal to 5×10⁻⁴ m/s, greater than or equal to 7×10⁻⁴ m/s, greater than or equal to 8×10⁻⁴ m/s, and greater than or equal to 10×10⁻⁴ m/s, and
the resilience speed of the microporous separator in its thickness direction is calculated by the following formula (1):

$$V = ( D 2 - D 1 ) / ( T 2 - T 1 ) \qquad formula ( 1 )$$

in the formula (1), V—a resilience speed, measured in m/s,
D2—a thickness of the microporous separator when its compressive loading force is reduced to 30 mN, measured in m,
D1—a thickness of the microporous separator when its compression deformation reaches its lowest point, measured in m,
T2—time required for the compressive loading force of the microporous separator to be reduced to 30 mN, measured in s,
T1—time required for the compression deformation of the microporous separator to reach its lowest point, measured in s,
test condition: the microporous separator is subjected to a loading force of 500 mN in its thickness direction, and kept this loading force for 300 s, followed by reducing the value of the loading force at a rate of 30 mN/min.

According to some embodiments of the present disclosure, the quantity proportion of polyolefin chain segment ingredients with a weight-average molecular weight greater than 5 million and below 9 million in the microporous separator accounts for 0 mol %-1 mol %, for example 0.5 mol %-1 mol %.

In the present disclosure, the polyolefin resin may be any polyolefin resin commonly used in the art for preparing a microporous separator for lithium battery, for example, it may be selected from polyethylene (including, for example, LDPE (Low-Density Polyethylene), LLDPE (Linear Low-Density Polyethylene), HDPE (High-Density Polyethylene), UHDPE (Ultra High-Density Polyethylene)), polypropylene, polybutene, polymethylpentene, a copolymer thereof, or a mixture thereof.

According to the present disclosure, the polyolefin resin may be used as long as it is capable of producing the microporous separator for lithium battery required by the present disclosure. In order to provide a microporous separator with superior resilience performance in its thickness direction, the quantity proportion of polyolefin chain segment ingredients with a weight-average molecular weight greater than 5 million and below 9 million in the polyolefin resin is 0 mol %-2 mol %, for example 1 mol %-1.5 mol %. In some embodiments, the quantity proportion of polyolefin chain segment ingredients with a weight-average molecular weight of 2 million to 5 million in the polyolefin resin is 5 mol %-9 mol %, for example 5 mol %-8 mol %, and 6 mol %-8 mol %. In some embodiments, a molecular weight distribution of the polyolefin resin is between 3 and 5, for example between 3.5 and 4.5.

In some specific embodiments of the present disclosure, the microporous separator satisfies one or more combinations of the following:
a. when measured under the test condition, a compression deformation rate of the microporous separator in its thickness direction is less than or equal to 2.5%, for example less than or equal to 1.8%, less than or equal to 1.5%, and less than or equal to 1%;
b. when measured under the test condition, a resilience recovery rate of the microporous separator in its thickness direction is greater than or equal to 0.5%, for example greater than or equal to 1%, greater than or equal to 1.5%, greater than or equal to 2%, and greater than or equal to 3%;
where the compression deformation rate, the resilience recovery rate and the resilience recovery rate are calculated by the following formulas:

$$compression deformation rate = ( original thickness - thickness when the compression deformation reaches the lowest point ) / original thickness \times 100 \% , \qquad formula ( 2 )$$

$$resilience deformation rate = ( original thickness - thickness when the compressive loading force is reduced to 30 mN ) / original thickness \times 100 \% , \qquad formula ( 3 )$$

$$resilience recovery rate = \vert compression deformation rate - resilience deformation rate \vert . \qquad formula ( 4 )$$

In order to obtain a microporous separator with superior resilience performance in the thickness direction, in some embodiments, the microporous separator of the present disclosure is a separator prepared by a wet process.

According to the present disclosure, the average pore diameter of the microporous separator may be 25 nm-50 nm, for example 30 nm-45 nm, and the thickness of the microporous separator may be 1 km-30 m, for example 4 m-12 km.

A second aspect of the present disclosure provides a preparation method for a microporous separator for lithium battery, including the following steps:
(a) melting and blending a mixture containing a polyolefin resin and a plasticizer to form a melt;
(b) extruding and solidifying the melt obtained in step (a) to obtain a thick sheet;
(c) stretching the obtained thick sheet in a machine direction (MD direction) and in a transverse direction (TD direction) perpendicular to the machine direction to obtain a stretched sheet;
(d) removing the plasticizer from the stretched sheet to obtain a precursor of separator;
(e) heat-setting the precursor of separator to obtain a microporous separator for lithium battery;
where, the polyolefin resin has a melt index of 0.01 g/10 min-3 g/10 min, for example 0.05 g/10 min-0.3 g/10 min, and the quantity proportion of polyolefin chain segment ingredients with a weight-average molecular weight of 2 million to 5 million in the polyolefin resin is 5 mol %-9 mol %, for example 5 mol %-8 mol %.

According to the present disclosure, by treating a mixture containing appropriate polyolefin resin and plasticizer according to the preparation method of the present disclosure, a microporous separator having excellent resilience performance in the thickness direction can be obtained, which is suitable for applications in lithium batteries.

In the present disclosure, the polyolefin resin may be any polyolefin resin commonly used in the art for preparing a microporous separator for lithium battery, for example, it may be selected from polyethylene (including LDPE, LLDPE, HDPE, UHDPE), polypropylene, polybutene, polymethylpentene, a copolymer thereof, or a mixture thereof.

In the present disclosure, the plasticizer is a small-molecule solvent that can dissolve the polyolefin resin, for example, it may be liquid paraffin, diethyl phthalate, palm oil, etc., for an example, liquid paraffin having a kinematic viscosity of 35 mm²/s-120 mm²/s at 40° C., and for another example liquid paraffin having a kinematic viscosity of 40 mm²/s-55 mm²/s at 40° C. The testing method for kinematic viscosity is based on GB/T 265.

According to the present disclosure, in step (a), a weight ratio of the polyolefin resin to the plasticizer is between 15:85 and 35:65, and for example between 18:82 and 23:77. Specifically, the weight ratio of the polyolefin resin to the plasticizer may be 15:85, 16:84, 17:83, 18:82, 19:81, 20:80, 21:79, 22:78, or 23:77, etc. By using the weight ratio of polyolefin resin to plasticizer mentioned above, the resilience performance of the microporous separator in the thickness direction can be improved.

In order to further improve the resilience performance of the microporous separator in the thickness direction, in the polyolefin resin, the quantity proportion of polyolefin chain segment ingredients with a weight-average molecular weight greater than 5 million and below 9 million is 0 mol %-2 mol %, for example 1 mol %-1.5 mol %. Furthermore, the molecular weight distribution of the polyolefin resin is in a range of 3-5, for example 3.5-4.5.

According to the present disclosure, in step (a), the treatment may be carried out using any of the existing methods capable of forming the mixture into a melt, for example, an extruder may be used for melt blending. As some embodiments, parameters of the extruder include: an extruder temperature of 150° C.-260° C., for example 180° C.-250° C., and an extruder screw speed of 60 r/min-125 r/min, for example 70 r/min-90 r/min.

According to the present disclosure, in step (b), the method of extruding and solidifying the melt into a thick sheet is capable of forming a thick sheet of a desired thickness.

The inventors of the present disclosure also found through in-depth research that controlling the parameters of the extrusion step in the separator manufacturing process helps to control the compression resistance of the separator. Under the condition of fixed extrusion quantity, the thick sheet in step (b) can be achieved by matching the die lip opening and casting speed. Assuming that the polymer has a melt die-swelling coefficient k, a melt flow rate out of the die v, a die lip opening a, a casting speed b, and a thickness of thick sheet h, then the parameters satisfy the following equation:

$$h = a \times k \times ( v / b ) , and \qquad equation ( 1 )$$

$$kv = ( h / a ) \times b , \qquad equation ( 2 )$$

where an expansion coefficient is defined as the formula (5):

A=h/a formula(5), and
when the A is smaller, the compression resistance of the separator is worse. When the mixture is extruded through the die lip of a die and attached to a casting roller for cooling and solidifying to form the thick sheet, the die lip opening is a, the thickness of thick sheet is h, and the expansion coefficient is defined as A=h/a, in some embodiments, the A is controlled to be greater than or equal to 1.2.

In the present disclosure, the control of the expansion coefficient A may be achieved by the roll speed of casting roller, the melt flow rate out of the die, and the die lip opening together. The melt flow rate out of the die may be comprehensively adjusted by the extruder screw speed and the temperature of die.

In some embodiments, the roll speed of the casting roller may be 3 m/min-8 m/min, for example 5 m/min-6 m/min. In some embodiments, the temperature of die may be 160° C.-240° C., for example 180° C.-220° C. In some other embodiments, the temperature of the casting roller may be 20° C.-60° C.

In some embodiments, the die lip opening may be 0.5 mm-4 mm, for example 0.8 mm-3 mm.

According to the present disclosure, in step (c), the thick sheet is stretched to obtain a stretched sheet, and the stretching includes a stretching in the MD direction and a stretching in the TD direction. Specifically, the stretching in the MD direction may be carried out before the stretching in the TD direction; or, the stretching in the TD direction may be carried out before the stretching in the MD direction.

According to some embodiments of the present disclosure, in step (c), the stretching in the MD direction is carried out at 80° C.-120° C. with a stretching ratio of 4 to 7, and the stretching in the TD direction is carried out at 90° C.-130° C. with a stretching ratio of 4 to 12. In some embodiments, the stretching in the MD direction is carried out at 95° C.-110° C. with a stretching ratio of 6 to 8, and the stretching in the TD direction is carried out at 105° C.-125° C. with a stretching ratio of 6 to 10.

According to the present disclosure, in step (d), the plasticizer may be removed from the stretched sheet by any method, for example, an extraction agent is used to remove the plasticizer from the stretched sheet. In some embodiments, the extraction agent may be an alkane-based extraction agent, or a halogenated hydrocarbon-based extraction agent, for example, dichloromethane.

As a method of removing the plasticizer from the stretched sheet by using an extraction agent, the plasticizer in the stretched sheet may be removed by means of circulation feed of the extraction agent. In some embodiments, the circulation feed rate of the extraction agent is 1 m³/h-5 m³/h. After extraction, the stretched sheet may be heated for drying by means of one or more of a hot roller, a heating plate, or a hot air. In some embodiments, a drying temperature is 20° C.-150° C.

According to the present disclosure, there is no specific limitation on the method and condition of the heat-setting treatment in step (e). For example, the heat-setting may include an oven heat treatment and a roller heat treatment. In some embodiments, the temperature of the oven heat treatment is 120° C.-150° C. and the temperature of the roller heat treatment is 50° C.-70° C. In addition, the time for oven heat treatment may be 2 s-30 s, and the time for roller heat treatment may be 5 s-60 s.

By adopting the above preparation method for the preparation, in obtained microporous separator, the quantity proportion of polyolefin chain segment ingredients with a weight-average molecular weight of 2 million to 5 million accounts for 5 mol %-8 mol %, for example 5 mol %-7 mol %. In some embodiments, in the microporous separator, the quantity proportion of polyolefin chain segment ingredients with a weight-average molecular weight greater than 5 million and below 9 million accounts for 0 mol %-1 mol %, for example 0.5 mol %-1 mol %. In some embodiments, the resilience speed of the microporous separator in the thickness direction is greater than or equal to 2×10⁻⁴ m/s, for example, greater than or equal to 3×10⁻⁴ m/s, greater than or equal to 5×10⁻⁴ m/s, greater than or equal to 7×10⁻⁴ m/s, greater than or equal to 8×10⁻⁴ m/s, and greater than or equal to 10×10⁻⁴ m/s.

The resilience speed of the microporous separator in the thickness direction is calculated by the following formula (1):

$$V = ( D 2 - D 1 ) / ( T 2 - T 1 ) \qquad formula ( 1 )$$

in the formula (1), V—a resilience speed, measured in m/s,
D2—a thickness of the microporous separator when its compressive loading force is reduced to 30 mN, measured in m,
D1—a thickness of the microporous separator when its compression deformation reaches the lowest point, measured in m,
T2—time required for the compressive loading force of the microporous separator to be reduced to 30 mN, measured in s,
T1—time required for the compression deformation of the microporous separator to reach its lowest point, measured in s,
test condition: the microporous separator is subjected to a loading force of 500 mN in its thickness direction, and kept this loading force for 300 s, followed by reducing the value of the loading force at a rate of 30 mN/min.

A third aspect of the present disclosure provides a microporous separator for lithium battery obtained by the preparation method of the second aspect of the present disclosure.

In the following examples and comparative examples, the testing methods for relevant parameters are as follows.
(1) The quantity proportion of polyolefin chain segments with a weight-average molecular weight of 2 million to 5 million, and the quantity proportion of polyolefin chain segments with a weight-average molecular weight greater than 5 million and below 9 million are measured in accordance with GB/T 36214.4-2018.
(2) The melt index is measured according to GBT3682.1-2018.
(3) The resilience speed, compression deformation rate, and resilience deformation rate are measured using a TMA (Thermomechanical Analysis) instrument (Waters, Q400).

### Example 1

The polyethylene resin having a melt index of 0.1 g/10 min and a molecular weight distribution of 4.5 was mixed with a plasticizer (paraffin oil with a kinematic viscosity of 45 mm²/s at 40° C.) in a weight ratio of 28:72, and then melted and blended through an extruder to form a melt; where, in the polyethylene resin, the quantity proportion of polyethylene chain segments with a weight-average molecular weight of 2 million to 5 million was 6 mol %, and the quantity proportion of polyethylene chain segments with a weight-average molecular weight greater than 5 million and below 9 million was 1.3 mol %. The extruder temperature was 220° C., and the extruder screw speed was 80 r/min.

The above-mentioned melt was cooled and solidified by a casting roller to form a thick sheet, with a temperature of casting roller of 25° C. The obtained thick sheet was subjected to a stretching treatment, with a stretching temperature of 95° C. and a stretching ratio of 6.3 in the MD direction; and a first stretching temperature of 110° C. and a stretching ratio of 6 in the TD direction.

After the plasticizer (paraffin oil) was removed, a second stretching in the TD direction was carried out at a temperature of 133° C., with a second stretching ratio of 1.4; and then the heat-setting treatment was performed at a temperature of 133° C.

### Examples 2 to 12 and Comparative Examples 1 to 2

Microporous separators are prepared with reference to the method of Example 1, and the differences between the preparation methods for microporous separator specifically adopted in Examples 2 to 12 as well as in Comparative Examples 1 to 2 and the preparation method of Example 1 are detailed in Table 1, where the parameters of Examples 2 to 12 as well as in Comparative Examples 1 to 2 which are not embodied in Table 1 are the same as those in Example 1.

### Examples 2-1 to 2-3

Microporous separators are prepared with reference to the method of Example 2, and the differences between the preparation methods for microporous separator specifically adopted in Examples 2-1 to 2-3 and the preparation method of Example 2 are detailed in Table 2, where the parameters of Examples 2-1 to 2-3 which are not embodied in Table 2 are the same as those in Example 2.

TABLE 1

| | Microporous separator | | | Raw material | | | |
|---|---|---|---|---|---|---|---|
| | | Quantity | | | Quantity | | |
| | | proportion | | | proportion | | |
| | Quantity | of | | Quantity | of | | |
| | proportion | polyolefin | | proportion | polyolefin | | |
| | of | chain | | of | chain | | |
| | polyolefin | segments | | polyolefin | segments | | |
| | chain | with a | | chain | with a | | |
| | segments | weight- | | segments | weight- | | |
| | with a | average | | with a | average | | |
| | weight- | molecular | | weight- | molecular | | |
| | average | weight | | average | weight | | |
| | molecular | greater than | Melt | molecular | greater than | Melt | Molecular |
| | weight of | 5 million | index | weight of | 5 million | index | weight |
| | 2 million to | and below | g/ | 2 million to | and below | g/ | dis- |
| | 5 million/% | 9 million/% | 10 min | 5 million/% | 9 million/% | 10 min | tribution |
| Example 1 | 5.3 | 1 | 0.13 | 6 | 1.3 | 0.1 | 4.5 |
| Example 2 | 6.2 | 1 | 0.11 | 7 | 1.3 | 0.08 | 4.5 |
| Example 3 | 7.4 | 1 | 0.07 | 8 | 1.2 | 0.05 | 4.5 |
| Example 4 | 7.9 | 1 | 0.04 | 9 | 1.3 | 0.01 | 4.5 |
| Example 5 | 6.2 | 0 | 1.6 | 7 | 0 | 1.4 | 4.5 |
| Example 6 | 6.2 | 0.5 | 1.5 | 7 | 0.2 | 1.2 | 4.5 |
| Example 7 | 9.2 | 0.6 | 0.07 | 10 | 0.3 | 0.04 | 3 |
| Example 8 | 6.2 | 1 | 0.10 | 7 | 1.3 | 0.08 | 5 |
| Example 9 | 6.3 | 1.5 | 0.13 | 7 | 1.8 | 0.09 | 4.5 |
| Example 10 | 6.2 | 1 | 0.12 | 7 | 1.3 | 0.08 | 4.5 |
| Example 11 | 6.2 | 0 | 1.6 | 7 | 0 | 1.4 | 4.5 |
| Example 12 | 6.2 | 1 | 0.11 | 7 | 1.3 | 0.08 | 4.5 |
| Comparative | 4.4 | 2 | 0.09 | 4.8 | 1.2 | 0.07 | 4.5 |
| Example 1 | | | | | | | |
| Comparative | 9.5 | 1 | 0.01 | 10 | 1.3 | 0.008 | 4.5 |
| Example 2 | | | | | | | |

| | Process | | | | | Resil- | Com- | Resil- | Resil- |
|---|---|---|---|---|---|---|---|---|---|
| | Roll speed | | Thickness | | | ience | pression | ience | ience |
| | of casting | Die lip | of thick | Expansion | Thick- | speed/ | defor- | defor- | re- |
| | roller/ | opening | sheet (h)/ | coefficient | ness/ | 10⁻⁴ | mation | mation | covery |
| | m/min | (a)/mm | mm | A | μm | μm/s | rate/% | rate/% | rate/% |
| Example 1 | 6 | 1.2 | 1.5 | 1.3 | 11 | 11.8 | 0.72 | 4.92 | 4.2 |
| Example 2 | 6 | 1.2 | 1.5 | 1.3 | 11 | 10.4 | 0.68 | 4.48 | 3.8 |
| Example 3 | 6 | 1.2 | 1.5 | 1.3 | 11 | 8.2 | 0.66 | 3.76 | 3.1 |
| Example 4 | 6 | 1.2 | 1.5 | 1.3 | 11 | 7.6 | 0.63 | 3.23 | 2.6 |
| Example 5 | 6 | 1.2 | 1.5 | 1.3 | 11 | 17.1 | 2.4 | 7.4 | 5 |
| Example 6 | 6 | 1.2 | 1.5 | 1.3 | 11 | 13.6 | 1.8 | 6.4 | 4.6 |
| Example 7 | 6 | 1.2 | 1.5 | 1.3 | 11 | 7.9 | 0.79 | 4.39 | 3.6 |
| Example 8 | 6 | 1.2 | 1.5 | 1.3 | 11 | 11.3 | 0.66 | 4.66 | 4 |
| Example 9 | 6 | 1.2 | 1.5 | 1.3 | 11 | 7.2 | 0.53 | 1.23 | 0.7 |
| Example 10 | 6 | 1.4 | 1.5 | 1.1 | 11 | 4.6 | 0.92 | 2.02 | 1.1 |
| Example 11 | 6 | 1.4 | 1.5 | 1.1 | 11 | 13.2 | 2.5 | 6.3 | 3.8 |
| Example 12 | 6 | 1.3 | 1.6 | 1.2 | 11 | 9.8 | 0.88 | 3.1 | 2.22 |
| Comparative | 6 | 1.2 | 1.5 | 1.3 | 11 | 1.9 | 0.54 | 1.14 | 0.6 |
| Example 1 | | | | | | | | | |
| Comparative | 6 | 1.2 | 1.5 | 1.3 | 11 | 1.8 | 0.58 | 1.28 | 0.7 |
| Example 2 | | | | | | | | | |

TABLE 2

| | Microporous separator | | Raw material | | | | | |
|---|---|---|---|---|---|---|---|---|
| | | Quantity | | Quantity | | | | |
| | | proportion | | proportion | | | | |
| | Quantity | of | Quantity | of | | | | |
| | proportion | polyolefin | proportion | polyolefin | | | | |
| | of | chain | of | chain | | | | |
| | polyolefin | segments | polyolefin | segments | | | | |
| | chain | with a | chain | with a | | | | |
| | segments | weight- | segments | weight- | | | | |
| | with a | average | with a | average | | | | |
| | weight- | molecular | weight- | molecular | | | | |
| | average | weight | average | weight | | | Process | |
| | molecular | greater than | molecular | greater than | Melt | Molecular | Extruder | Extruder |
| | weight of | 5 million | weight of | 5 million | index | weight | temper- | screw |
| | 2 million to | and below | 2 million to | and below | g/ | dis- | ature/ | speed |
| | 5 million/% | 9 million/% | 5 million/% | 9 million/% | 10 min | tribution | ° C. | r/min |
| Example 2-1 | 6.2 | 1 | 7 | 1.3 | 0.08 | 4.5 | 220 | 80 |
| Example 2-2 | 6 | 1.1 | 7 | 2 | 0.07 | 4.5 | 220 | 125 |
| Example 2-3 | 6.3 | 1.3 | 7 | 2 | 0.07 | 4.5 | 260 | 80 |

| | Process | | | | | Resil- | Com- | Resil- | Resil- |
|---|---|---|---|---|---|---|---|---|---|
| | Roll speed | | Thickness | | | ience | pression | ience | ience |
| | of casting | Die lip | of thick | Expansion | Thick- | speed/ | defor- | defor- | re- |
| | roller/ | opening | sheet (h)/ | coefficient | ness/ | 10⁻⁴ | mation | mation | covery |
| | m/min | (a)/mm | mm | A | μm | μm/s | rate/% | rate/% | rate/% |
| Example 2-1 | 6 | 1.2 | 1.5 | 1.3 | 11 | 8.4 | 0.68 | 4.48 | 3.8 |
| Example 2-2 | 6 | 1.2 | 1.5 | 1.3 | 11 | 8.3 | 0.67 | 4.47 | 3.8 |
| Example 2-3 | 6 | 1.2 | 1.5 | 1.3 | 11 | 8.3 | 0.66 | 4.36 | 3.7 |

As can be seen from Examples 1-4 in Table 1, the resilience speed, resilience recovery rate, compression deformation rate, and resilience deformation rate of the microporous separator all decrease in a unified trend as the quantity proportion of polyolefin chain segments with a weight-average molecular weight of 2 million to 5 million increases.

From the comparison among Examples 5-6, Example 9, and Example 2, it can be seen that when the quantity proportion of polyolefin chain segments with a weight-average molecular weight of 5 million to 9 million decreases (<1%), the resilience speed, resilience recovery rate, and resilience deformation rate of the microporous separator increase greatly, but the compression deformation rate also increases (i.e. being deteriorated) correspondingly; when this quantity proportion increases (>1%), the compression deformation rate decreases (i.e. being improved to some extent), but the resilience speed and resilience recovery rate decrease.

From the comparison between Examples 7-8 and Example 2, it can be seen that the change in the molecular weight distribution of the raw material also has an impact on the performances of the microporous separator in the thickness direction, but the impact is not significant.

From the comparison between Example 10, 12 and Example 2, as well as from the comparison between Example 11 and Example 5, it can be seen that when the expansion coefficient is ≥1.2, better compression resilience performances in the thickness direction are obtained, and with the increase of the expansion coefficient, the compression resilience performances in the thickness direction are all improved. When the expansion coefficient is <1.2, the compression resilience performances in the thickness direction all are reduced.

From Examples 2-1 to 2-3 in Table 2, it can be seen that the regulation of quantity proportion of polyolefin chain segments with a weight-average molecular weight of 2 million to 5 million in the microporous separator can be achieved by mutual matching of the extruder process and the raw materials.

Unless otherwise specified in the context, the singular forms of “a”, “an”, and “the” in the present description and appended claims include the plural forms. Unless otherwise defined, all technical and scientific terms used herein have the same meanings as those commonly understood by the person skilled in the art. In addition to the specific order disclosed, the methods described herein may be performed in any logically possible order.

The representative examples are intended to assist in illustrating the present disclosure, and are not intended for or should not be interpreted as limiting the scope of the disclosure. In fact, in addition to those shown and described herein, various modifications and many other embodiments of the present disclosure will become apparent to the person skilled in the art, including the embodiments and references to the scientific and patent documents cited herein. The embodiments contain important additional information, examples, and guidance that may be employed by the practice of the present disclosure in its various embodiments and equivalents.

What is claimed is:

1. A microporous separator for lithium battery, comprising a polyolefin resin, wherein the microporous separator has a melt index of 0.04 g/10 min-3 g/10 min; a quantity proportion of polyolefin chain segment ingredients with a weight-average molecular weight of 2 million to 5 million in the microporous separator is 5 mol %-8 mol %; a resilience speed of the microporous separator in its thickness direction is greater than or equal to 2×10⁻⁴ m/s; and
the resilience speed of the microporous separator in its thickness direction is calculated by following formula:
$$V = ( D 2 - D 1 ) / ( T 2 - T 1 )$$
in the formula, V—the resilience speed, measured in m/s,
D2—a thickness of the microporous separator when its compressive loading force is reduced to 30 mN, measured in m,
D1—a thickness of the microporous separator when its compression deformation reaches the lowest point, measured in m,
T2—time required for the compressive loading force of the microporous separator to be reduced to 30 mN, measured in s,
T1—time required for the compression deformation of the microporous separator to reach the lowest point, measured in s,
test condition: the microporous separator is subjected to a loading force of 500 mN in its thickness direction, and kept the loading force for 300 s, followed by reducing a value of the loading force at a rate of 30 mN/min.

2. The microporous separator for lithium battery according to claim 1, wherein the quantity proportion of polyolefin chain segment ingredients with a weight-average molecular weight of 2 million to 5 million in the microporous separator is 5 mol %-7 mol %.

3. The microporous separator for lithium battery according to claim 1, wherein a quantity proportion of polyolefin chain segment ingredients with a weight-average molecular weight greater than 5 million and below 9 million in the microporous separator is 0 mol %-1 mol %.

4. The microporous separator for lithium battery according to claim 1, wherein a quantity proportion of polyolefin chain segment ingredients with a weight-average molecular weight greater than 5 million and below 9 million in the microporous separator is 0.5 mol %-1 mol %.

5. The microporous separator for lithium battery according to claim 1, wherein the microporous separator satisfies one or more of the following:
a. when measured under the test condition, a compression deformation rate of the microporous separator in its thickness direction is less than or equal to 2.5%;
b. when measured under the test condition, a resilience recovery rate of the microporous separator in its thickness direction is greater than or equal to 0.5%;
wherein,
$$the compression deformation rate = ( original thickness - thickness when the compression deformation reaches the lowest point ) / original thickness \times 100 \% ,$$
$$a resilience deformation rate = ( original thickness - thickness when the compressive loading force is reduced to 30 mN ) / original thickness \times 100 \% ,$$
$$a resilience recovery rate = \vert the compression deformation rate - the resilience deformation rate \vert .$$

6. The microporous separator for lithium battery according to claim 1, wherein the polyolefin resin has a molecular weight distribution between 3 and 5.

7. The microporous separator for lithium battery according to claim 1, wherein the quantity proportion of polyolefin chain segment ingredients with the weight-average molecular weight of 2 million to 5 million in the polyolefin resin is 5 mol %-9 mol %.

8. The microporous separator for lithium battery according to claim 1, wherein a quantity proportion of polyolefin chain segment ingredients with a weight-average molecular weight greater than 5 million and below 9 million in the polyolefin resin is 0 mol %-2 mol %.

9. The microporous separator for lithium battery according to claim 1, wherein the microporous separator is a separator prepared by a wet process.

10. The microporous separator for lithium battery according to claim 1, wherein the polyolefin resin is selected from polyethylene, polypropylene, polybutene, polymethylpentene, a copolymer thereof, or a mixture thereof.

11. The microporous separator for lithium battery according to claim 1, wherein the microporous separator has an average pore diameter of 25 nm-50 nm; and the microporous separator has a thickness of 1 m-30 m.

12. A preparation method for a microporous separator for lithium battery, comprising the following steps:
(a) melting and blending a mixture containing a polyolefin resin and a plasticizer to form a melt;
(b) extruding and solidifying the melt obtained in step (a) to obtain a thick sheet;
(c) stretching the obtained thick sheet in a machine direction (MD direction) and in a transverse direction (TD direction) perpendicular to the machine direction to obtain a stretched sheet;
(d) removing the plasticizer from the stretched sheet to obtain a precursor of separator;
(e) heat-setting the precursor of separator to obtain the microporous separator for lithium battery;
where, the polyolefin resin has a melt index of 0.01 g/10 min-3 g/10 min; and a quantity proportion of polyolefin chain segment ingredients with a weight-average molecular weight of 2 million to 5 million in the polyolefin resin is 5 mol %-9 mol %.

13. The preparation method according to claim 12, wherein in step (a), a quantity proportion of polyolefin chain segment ingredients with a weight-average molecular weight greater than 5 million and below 9 million in the polyolefin resin is 0 mol %-2 mol %;
further, the quantity proportion of polyolefin chain segment ingredients with the weight-average molecular weight greater than 5 million and below 9 million in the microporous separator is 0 mol %−1 mol %;
further, a resilience speed of the microporous separator in its thickness direction is greater than or equal to 2×10⁻⁴ m/s; and
the resilience speed of the microporous separator in its thickness direction is calculated by following formula:
$$V = ( D 2 - D 1 ) / ( T 2 - T 1 )$$
in the formula, V—the resilience speed, measured in μm/s,
D2—a thickness of the microporous separator when its compressive loading force is reduced to 30 mN, measured in m,
D1—a thickness of the microporous separator when its compression deformation reaches the lowest point, measured in m,
T2—time required for the compressive loading force of the microporous separator to be reduced to 30 mN, measured in s,
T1—time required for the compression deformation of the microporous separator to reach the lowest point, measured in s,
test condition: the microporous separator is subjected to a loading force of 500 mN in its thickness direction, and kept the loading force for 300 s, followed by reducing a value of the loading force at a rate of 30 mN/min.

14. The preparation method according to claim 12, wherein in step (a), the polyolefin resin has a molecular weight distribution of 3-5.

15. The preparation method according to claim 12, wherein in step (a), the quantity proportion of polyolefin chain segment ingredients with the weight-average molecular weight of 2 million to 5 million in the microporous separator is 5 mol %-8 mol %.

16. The preparation method according to claim 12, wherein in step (a), a weight ratio of the polyolefin resin to the plasticizer in step (a) is between 15:85 and 35:65.

17. The preparation method according to claim 12, wherein in step (a), an extruder is used for the melting and blending, and the extruder has parameters comprising: an extruder temperature of 150° C.-260° C. and an extruder screw speed of 60 r/min-125 r/min.

18. The preparation method according to claim 17, wherein in step (b), the mixture is extruded through a die lip of a die and attached to a casting roller for cooling and solidifying to form a thick sheet, a die lip opening being a, a thickness of thick sheet being h, and an expansion coefficient being defined as A=h/a, wherein A is controlled to be greater than or equal to 1.2;
further, the casting roller has a roll speed of 3 m/min-8 m/min, and the die has a temperature of 160° C.-240° C.

19. The preparation method according to claim 12, wherein in step (c), the stretching in the MD direction is carried out at 80° C.-120° C. with a stretching ratio of 4 to 7, and the stretching in the TD direction is carried out at 90° C.-130° C. with a stretching ratio of 4 to 12.

20. The preparation method according to claim 12, wherein in step (e), the heat-setting comprises an oven heat treatment and a roller heat treatment; further, the oven heat treatment has a temperature of 120° C.-150° C., and the roller heat treatment has a temperature of 50° C.-70° C.
